(19) United States
(12) Patent Application Publication
(10) Pub. No.: US 2009/0249711 A1
(43) Pub. Date: Oct. 8, 2009

(54) Outdoor Flooring and Assembly Method Thereof

(76) Inventor: Gabriele Galimberti, Lomagna (IT)

Correspondence Address: H. JAY SPIEGEL - H. JAY SPIEGEL & ASSOCIATES, P.O. BOX 11, MOUNT VERNON, VA, 22121, US

(21) Appl. No.: 12/227,787

(22) PCT Filed: May 29, 2007
(86) PCT No.: PCT/IB2007/001391

§ 371 Date: Nov. 26, 2008

(30) Foreign Application Priority Data
May 29, 2006 (IT) RM2006A000284

(51) Int. Cl. E04B 1/61; E04B 2/82; E04B 1/00; G01B 1/00

(52) U.S. Cl. 52/127.6; 52/127.12; 52/745.19; 33/526; 33/562

(57) ABSTRACT

An easy-to-install outdoor wooden flooring, with possibly treated, very high durability materials, suitably robust and safe for passers-by and characterised by low manufacturing costs. An assembly method of the aforesaid flooring is advantageously provided capable of simplify the installation operations, specifically in virtue of the use of appropriately configured assembly templates.

### FIELD OF THE INVENTION

The present invention relates to an outdoor wooden flooring and to the assembly method thereof.

### STATE OF THE ART

The request for outdoor wooden floors is constantly on the rise. The main zones of use are swimming pool areas, open spaces of public venues, such as bars and restaurants, common areas of residential buildings, terraces.

Various outdoor wooden flooring systems are known in the prior art. As all materials, wood varies its dimensions according to environmental conditions. Specifically, wood is unaffected by frost and its dimensions change according to humidity; for this reason, the laying of wooden floors exposed to the weather elements is performed by leaving an expansion gap between adjacent staves. This gap will reduce in size to the minimum in humid and rainy periods (December in Italy) and will increase to the maximum during dry and sunny periods (June in Italy).

Such flooring generally consists of concrete screeds or iron or wood framed supporting structures onto which the wood staves are fastened. These floorings may present various problems, such as:
poor water draining. Stagnation of water is the main cause of possible decay and thus of the durability of the flooring;
high installation costs;
visible, unsightly and often poorly aligned fastenings (traditionally entrusted to screws with mechanical hold entrusted to the active under head diameter of 15 mm of more).

In order to solve these problems, a number of outdoor wooden floor assembly systems have been introduced on the market. Such systems have the following disadvantages in common:

1) The draining systems are essentially left to the initiative of the installer who will decide how to proceed on a case-by-case basis; the installer will prepare a substructure consisting of standard metallic section bars or wooden strips, or even using concrete brick raising elements procurable on the raised floor market. This fact implies that the quality of the finished product is not constant and often of low level, despite the high incurred floor installation costs.

It is important to remember that the wood may be exposed to the weather elements only if the correct constructive contrivances aimed at obtaining an effective drainage are respected. Such contrivances are hardly within the scope of the installers' knowledge background.

2) Long assembly times.
3) Difficulty of fastening special long parts along walls or in corners.

Systems with screws inserted in the gaps so as to lock the adjacent staves by means of the aid of specific metallic elements are known in the prior art, such as for example those described in patent EP 1 106 842 B1.

These systems present the following drawbacks:
the shrinkage of the wood causes a slaking of the fastening
the removal of single staves is possible but slow
appearance requires that the heads of the staves are covered by further elements due to the specific section bar
the fastening system is not invisible, being visible between the staves.

Other known systems use specific plates fastened to the substructure and to the stave leading to the formation of a key-fitted system.

These system present the following drawbacks:
the wood does not present room for expansion, and may thus be only installed in conditions of high humidity, so that it can only shrink;
the removal of single staves is not contemplated;
the fastening system is not invisible, but is visible between the staves.

Another disadvantage of the existing floors is represented by the opening of broad gaps in which spike heels may get caught.

It is thus felt the need to make a flooring and an assembly method thereof which allows to overcome such drawbacks.

### SUMMARY OF THE INVENTION

An object of the present invention is to make an outdoor stave flooring system which is easy to install, suitably robust, which presents low manufacturing costs and which offers the possibility of installing the staves with very small gaps so as to be safe also for passers-by wearing shoes with very thin heels.

A further object is to define an assembly method of the aforesaid flooring capable of simplifying the installation operations, placing them within the capacity also of unspecialised workers, specifically in virtue of the use of an appropriately configured assembly template.

It is thus of the object of the present invention a flooring according to claim 1.

It is a further object of the present invention an assembly method of said flooring according to claim 8.

It is a further object of the present invention a template to be used in the assembly method, as described in claim 14.

It is a further object of the present invention a template to be used in the assembly method, as described in claim 14.

It is a further object of the present invention a semiautomatic drilling and screwing system to be used in the assembly method, as described in claim 19.

Further features of the present invention are described in the dependent claims, all the claims forming integral part of the present invention.

The installation with the assembly method of the invention ensures a high efficiency and less work for the installer, considerably reducing laying costs.

The fact of contemplating the use of double-threaded screws, sunken into the wooden staves and into the support section bars, preferably formed by aluminium, of the staves themselves, allows to have a laying gap reduced to 1 mm and an optimal fastening of the staves to, the section bars. The fastening operation of the wooden staves or strips to the section bars and the distancing between the adjacent staves is facilitated by means of the use of advantageously shaped templates or shapes.

A further advantage is determined by the fact that it contemplates a ventilated laying system on raised aluminium section bars which avoids the creation of a water stagnation, allowing a very high durability of the flooring. The system is further designed so as to allow an effective drainage: the flooring will thus rapidly dry after rain or washing. The cleaning operations may thus be performed rapidly with a simple jet of water which will convey all the dirt into the drain openings by means of appropriate channels arranged in the substructure.

Finally, the possibility of laying the section bars either on a drillable supporting structure or on waterproofing sheath is advantageously contemplated. The dependent claims describe preferred embodiments of the invention.

### BRIEF DESCRIPTION OF THE DRAWINGS

Further features and advantages of the invention will be more apparent in the light of the detailed description of a preferred but not exclusive embodiment of a flooring and of the assembly method thereof, illustrated by way of non-limitative example, with the aid of the accompanying drawings, in which:

FIG. 1a shows an exploded view of a part of the flooring of the invention during assembly;

FIG. 1b shows an exploded view of a part of the flooring of the invention, according to a variant, during assembly;

FIG. 2 shows a first diagram for the fastening of a first component to the flooring;

FIG. 3 shows a second diagram for the fastening of a said first component;

FIG. 4a shows a cross view of a second component of the flooring of the invention;

FIG. 4b shows a cross view of said first component of the flooring of the invention;

FIG. 4c shows a cross view of a variant of said first component;

FIG. 5 shows a third component of the flooring of the invention;

FIG. 6 shows a perspective view of a template used in the method of the invention;

FIG. 7 shows a possible section view of a wooden strip or stave of the flooring of the invention;

FIG. 8 shows an exploded view of a part of the flooring of the invention, according to a further variant, during assembly;

FIG. 9 shows an exploded view of a part of the flooring of the invention, according to a further variant, during assembly;

FIG. 10 shows a perspective view of a template variant used in the assembly method of the invention;

FIG. 11 shows in perspective view a further variant of a template used in the method according to the invention;

FIG. 12 shows a drilling and fastening system for the assembly of the floor.

### DETAILED DESCRIPTION OF PREFERRED EMBODIMENTS OF THE INVENTION

The figures show an outdoor flooring, object of the present invention, adapted to be fastened or simply rested on a supporting structure 1, e.g. non-limitatively a concrete screed, and comprising:
a plurality of section bars 2, of predetermined length and defining first longitudinal axes, preferably but not necessarily formed by aluminium,
adhering rubber pads 5 of section bars 2 to supporting structure 1, said rubber pads are mounted on section bars 2,
wooden strips or staves 3, possibly treated, defining second longitudinal axes, orthogonal to said first axes, and fastened onto section bars 2, by means of screws 4 or other appropriate fastening systems.

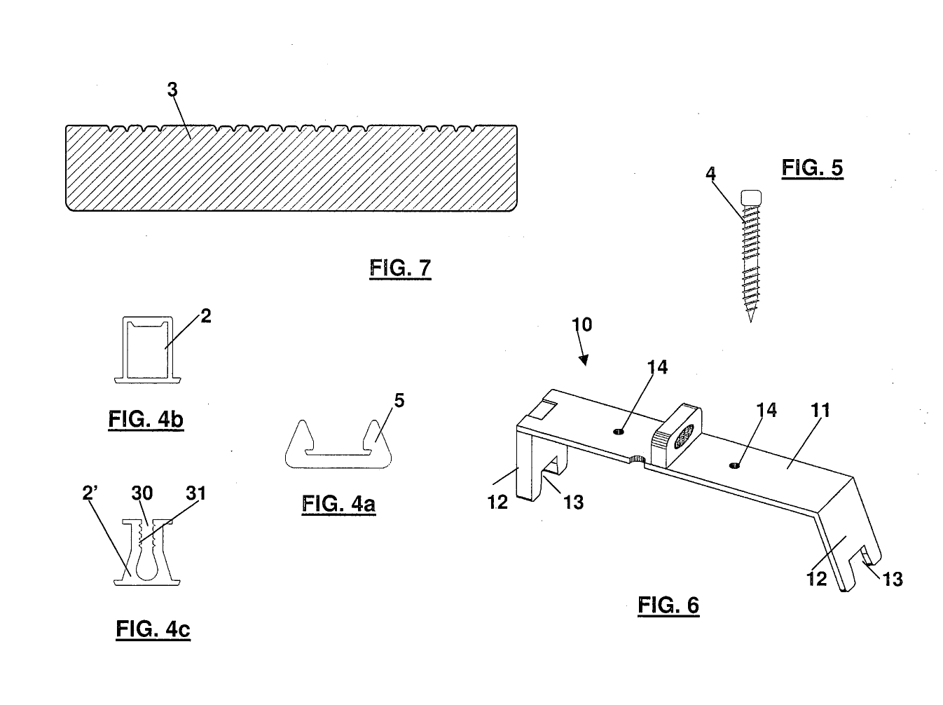

Adhering rubber pads 5, preferably formed by EPDM or other UV and frost resistant material, are mounted on the lower surface of each section bar 2, reciprocally distanced by approximately 4-60 cm. FIG. 4a shows a section of a rubber pad 5 corresponding to that of the lower surface of the cross section of a section bar 2, shown in the variant in FIG. 4b, and a section bar 2′ in the variant in FIG. 4c.

Section bars 2 adhere with the lower surface of supporting structure 1 by means of rubber pads 5, while the upper surface acts as a support for wooden strip 3. Possible irregularities of supporting structure 1 may be recovered by interposing appropriate shims between rubber pads 3 and the supporting structure, preferably and preventively glued to the lower side of the rubber pads.

A section of an example of strip 3 is shown in FIG. 7. Section bars 2 are advantageously arranged at a reciprocal distance of approximately 10-100 cm.

Said strips 3 are fastened to section bars 2 by means of double-threaded screws 4, such as the one described for example in FIG. 5, so as to allow a differentiated advancement in wooden strips 3 and in aluminium section bars 2, respectively. A complete tightening it thus guaranteed. The screws used are advantageously with very small 6 mm head. Even if the screws remain in sight, their head of only 6 mm is nearly not visibly perceivable, and certainly not more so than concealed fastenings. Resistance to extraction is furthermore ensured by the double threading.

Advantageously, the dilatation space or gap between two adjacent strips may be reduced to 1 mm. In the case of laying on steps, gradients or in general in all cases which could imply a movement of the flooring, it is also possible to fasten support section bar 2 to the supporting structure.

A fastening by means of bolts is suitable in the cases of drillable support structures in which the waterproofing sheath is absent. A fastening by means of glue is adapted for laying on non-drillable supporting structures.

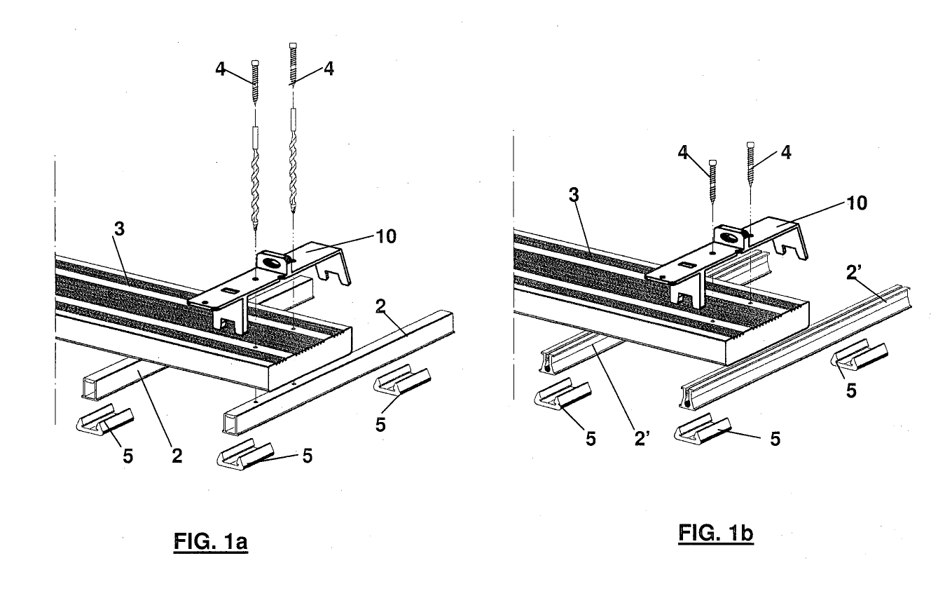

A further advantage of the present invention is that of providing a simple and rapid assembly method of the aforesaid flooring, shown in FIG. 1a for section bar variant 2 in FIG. 4b, and in FIG. 1b for section bar variant 2′ in FIG. 4c. Such method provides, once a supporting structure has been arranged with a suitably regular supporting plane, the assembly of adhering rubbed pads 5 onto the lower surface of section bars 2 previously cut to size. After appropriately mounting the reciprocally distanced rubber pads, a plurality of section bars 2, also appropriately and reciprocally distanced according to the longitudinal extension of strip 3, arranging them in their final position, are made to adhere to supporting structure 1 by means of the rubber pads. At this point, strips 3 are arranged on said plurality of section bars 2, being a strip arranged parallelly to the other, so that the longitudinal axes of strips 3 are essentially orthogonal to the longitudinal axes of section bars 2 and so as to make a plane essentially parallel to that of the supporting structure.

The adjacent strips are thus distanced by resting an assembly template 10 on a strip 3 at a section bar 2 underneath. An example of such template 10 is shown in FIG. 6.

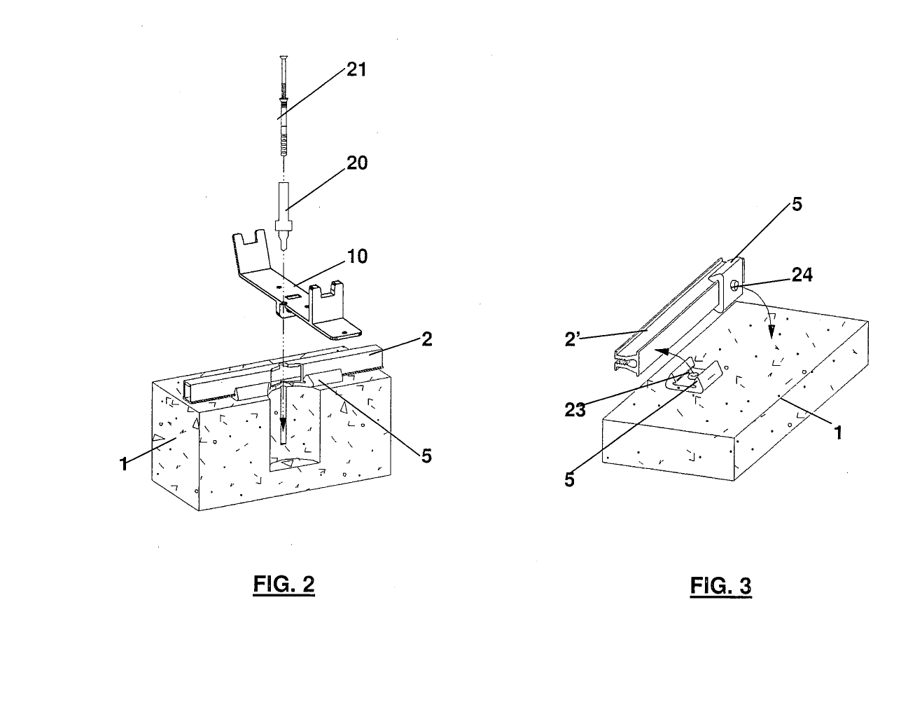

Template 10 advantageously comprises three sides, with one side 11 essentially orthogonal with respect to the other two sides 12. These second sides 12 each contemplate a cut 13 shaped so as to, interlock the template to section bar 2. The thickness of side 12 allows to appropriately distance reciprocally adjacent strips. This template 10 has the further function of facilitating an alignment of the holes through which to screw screws 4 fastening strip and section bar. First side 11 is indeed provided with guide holes 14 to possibly drill a pilot hole in strip and section bar underneath in a safe and stable manner. The possible fastening of section bars 2 to supporting structure 1 contemplates the following steps shown in FIG. 2 in the case of fastening by means of bolts 21
assembling adhering rubber pads 5 onto section bars 2 at a close distance of approximately 50 mm to avoid bending when bolt 21 is tightened;
arranging section bars 2 in the final position on supporting structure 1;
drilling a pilot hole in section bars 2 with an appropriate double diameter bit, e.g. such as bit 20 in FIG. 2;
drilling supporting structure 1 with a concrete drill,
fastening with bolts 21, preferably formed by stainless steel.

An advantageous variant of the flooring of the invention contemplates the use of longitudinal section bars 2′, preferably formed by aluminium provided with a longitudinal groove 30. Advantageously, the upper part of groove 30 contemplates a knurled profile 31 adapted to accommodate screw 4. This allows to avoid the making of pilot hole in the aluminium section bar. A section bar 2′ with the aforesaid features is shown in FIG. 1b and a side view thereof is shown in FIG. 4c. Alternatively, by using a specific self-tapping screw for wood, the need for a pilot hole in the wooden strip may also be avoided.

Advantageously, to facilitate the section bar pilot hole drilling and the supporting structure drilling operations, template 10 may be arranged upside-down, as shown in FIG. 2, after having arranged the section bar in the end position.

With the floor and the assembly method of the invention, short assembly times are obtained and furthermore the strips are separately removable.

Instead, in the case of fastening of the section bar to the supporting structure by means of glue, the following steps shown in FIG. 3 are contemplated:
applying a first spot or drop of glue 23 inside adhering rubbed pads 5 and mounting them on section bar 2;
applying a second spot of glue 24 under rubber pads 5 and arranging section bar 2 in the final position by performing a slight pressure.

Second spot of glue 24 may be alternatively applied directly onto supporting structure 1 in the previously determined supporting positions of the rubber pads.

Other possible variants of the described non-limitative example are possible, without because of this departing from the scope of protection of the present invention, comprising all the equivalent implementations for a person skilled in the art.

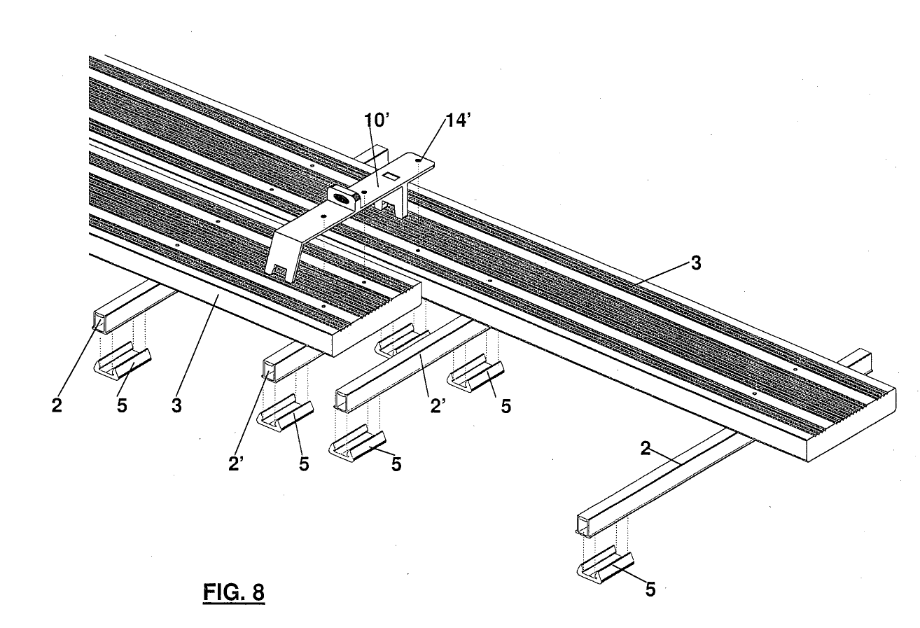

FIG. 8 shows a variant of the assembly process of the flooring object of the invention, usable in points in which the end parts of two strips 3 to be consecutively installed protrudingly extend with respect to the positions of two consecutive section bars 2. In order to avoid deformations of the strips, two additional section bars 2′ are inserted, with corresponding rubber pads 5, at the ends of strips 3, under these. Additional section bars 2′ are only slightly longer than the width of the strips, so as to be inserted also under the abreast strips. Additional section bars 2′ are then fastened with screws 4 both to consecutive lists 3 and to those abreast, by means of template.

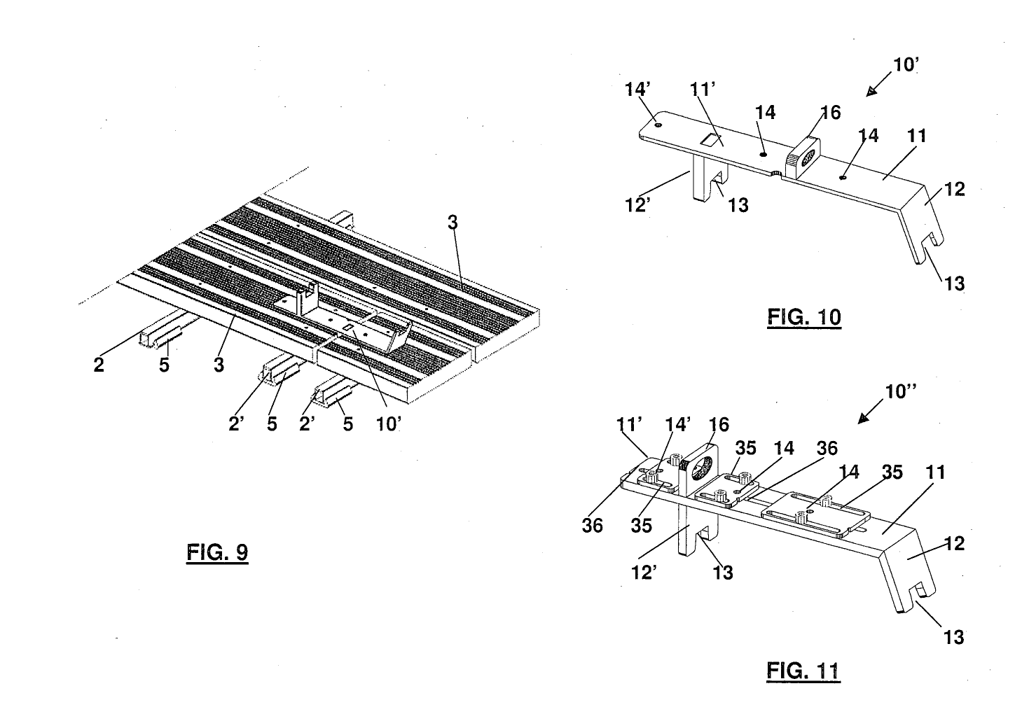

A template 10′ like the one shown in FIG. 9 may be advantageously used. With respect to the template in FIG. 6, the variant in FIG. 9 present yet another first side 11 and two second sides 12, and 12′ with corresponding slot 13. The second sides allow to appropriately distance the reciprocally adjacent strips. First side 11 is provided with guide holes 14, and further comprises an extension 11′, on the opposite side with respect to second side 12′, provided with at least one guide hole 14′. Template 10′ further comprises a handle 16, in central position on first side 11, on the opposite side with respect to second sides 12, 12′.

The template in FIG. 9 is used in assembly as that in FIG. 6. In the case of protrudingly extending strips 3, as shown in FIG. 8, extension 11′ of the first side allows to use guide hole 14′ to obtain a supplementary hole in the abreast list, and to fasten addition section bar 2′ also to the abreast list, ensuring hold and stability of the overall assembly.

Handle 16 has the further function of appropriately distancing the two consecutive strips during installation. As shown in FIG. 10, two consecutive strips are positioned at a relative distance equal to the thickness of handle 16 of template 10′, which is used upside-down so as to insert handle 16 between the two strips. The template variant shown in FIG. 9 may obviously be used in all steps of the assembly method of the present invention.

A further variant of template 10″ is shown in FIG. 11. With respect to variant in FIG. 9, this template presents slides 35 on the surface of first side 11, so as to adjust the position of holes 14, in longitudinal direction on the slide and thus transversal on strip 3. Holes 14 are now present on the slides, while corresponding adjustment slots 36 are found on the first side. Slides 35 may not be used, leaving the operator free to decide on the point in longitudinal direction where to drill the hole, within slots 36.

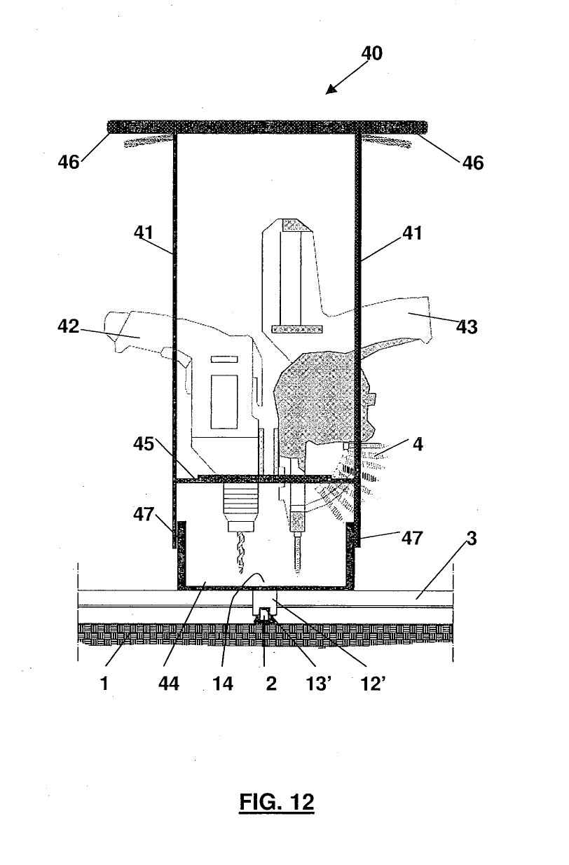

As a further variant of the flooring assembly method, instead of the templates described above, a semiautomatic drilling and screwing system 40 shown in FIG. 12 may be advantageously used.

System 40 provides a support 41, with corresponding gripping handles 46, on which automatic drills 42 and screw runners 43 with screw loaders 4 are installed. The drills and the screw runners are positioned on slides 45 which allow the translation in horizontal direction thereof, parallelly to strip 3. The drills and the screw runners may be single or paired, one for each hole to be made on the section bar.

Lower part 44 of support 41 replaces first side 11 of template, and is positioned in contact with strip 3 to be fastened onto section bar 2. A pair of second vertical sides 12″ with corresponding slots 13″, which during assembly are inserted on section bars 2 for centring, are connected to lower part 44.

During assembly, after centring system 40 on section bar 2, by means of slots 13′, two drills 42 are positioned at holes 14 to be made in strip 3 and on section bar 2, centering them by moving slide 45 in horizontal direction parallel to strip 3. These are then manoeuvred by pressing on vertical slides 47 on the side walls of support 41 to make the holes, with movement orthogonal to the section bar. After having made the holes in strip 3 and in section bar 2, the two screw runners 43 are positioned at holes 14 by means of a further movement of slide 45. They are then manoeuvred by pressing on vertical slides 47, with orthogonal movement with respect to the section bar, so as to fasten screws 4 in holes, thus obtaining the fastening of strip 3 on section bar 2.

This operation is repeated on all the points where to fasten screws 4, to secure strips 3 onto section bars 2.

Drills 42 and screw runners 43 are of known type and procurable on the market. According to a further variant of the assembly method, section bars 2 may be fastened to strips 3 with screws which, instead of presenting themselves in transversal pairs (see the position of holes 14 in the figures) are singular and alternated in arrangement towards the edges of the strip. In this manner, the creation of surface stresses on the strips, normally formed by wood, are avoided, due to the possible different thermal expansion coefficient of section bar 2 and strip 3, stresses which could also cause cracking of the strip itself.

1. An outdoor flooring adapted to be fastened onto a supporting structure, comprising:
a plurality of section bar elements, defining first longitudinal axes, adapted to be fastened to said supporting structure;
strips preferably formed by wood and supported by said section bar elements, said strips defining second longitudinal axes, essentially transversal to said first axes, and being reciprocally distanced by a first predetermined distance;
fastening means of said strips (to said section bar elements, such as to allow a differentiated advancement in the wooden strips and in the section bars, respectively.

2. A flooring according to claim 1, wherein said section bar elements are reciprocally distanced at a second distance whose value is approximately 10-100 cm.

3. A flooring according to claim 2, wherein said section bar elements are fixed to said supporting structure by means of rubbery material elements mounted on each of said section bar elements.

4. A flooring according to claim 1, wherein said supporting structure is preferably formed by concrete, and the strips are formed by a thermally treated wood.

5. A flooring according to claim 1, wherein said section bar elements are formed by aluminium and are fastened to the supporting structure by means of bolts or glue.

6. A flooring according to claim 1, wherein said first predetermined distance is either greater than or equal to 1 mm.

7. A flooring according to claim 1, wherein said fastening means of said strips to said section bar elements comprise either double-threaded screws or self-tapping screws.

8. An assembly method for a flooring according to claim 1, comprising the steps of:
a) fixing said section bar elements to a supporting structure in predetermined positions,
b) arranging strips preferably formed by wood onto said plurality of reciprocally parallel section bar elements so that the longitudinal axes of said strips are transversal to the axes of said section bar elements,
c) distancing the adjacent strips at a first predetermined distance by arranging an assembly device on a strip in correspondence of underneath the section bar elements in.
d) fixing the strips to the section bar elements with fastening means by means of guide holes provided on said assembly device.

9. A method according to claim 8, wherein rubber elements are fastened to said section bar elements, before fastening to said supporting structure in interposed position.

10. A method according to claim 8, wherein there is contemplated the fastening of the section bar elements to the supporting structure by contemplating for the fastening:
applying a first spot of glue inside the rubber material elements;
applying a second spot of glue either onto a contact surface of the elements with the supporting structure or directly onto the supporting structure in said predetermined positions.

11. A method according to claim 8, wherein there is provided a fastening of the section bar elements to the supporting structure by contemplating before step b):
drilling the section bar elements,
drilling the supporting structure
fastening the section bar elements to the supporting structure by means of bolts.

12. A method according to claim 8, wherein at the points in which the end parts of two consecutive strips overhangingly protrude with respect to the positions of two consecutive section bars, there are inserted two additional section bars, said additional section bars being only slightly longer than said strips width, so as to be inserted also under the strip abreast to said consecutive strips.

13. A method according to claim 8, wherein said supporting structure is of the regular type.

14. A template adapted to make said assembly device in an assembly method according to claim 8, comprising three sides, with a first side essentially orthogonal with respect to the other two second sides, wherein each of said second sides has a slot in said thickness shaped so as to allow the locking of the template on the section bar elements, and said first side is provided with guide holes to facilitate the fastening between each strip and the section bar elements underneath.

15. A template according to claim 14, wherein said first side comprises a overhanging extension with respect to said second sides, provided with at least one guide hole, said overhanging extension allowing to obtain a supplementary hole in an abreast strip, and to fasten said additional section bar also to the abreast strip.

16. A template according to claim 14, comprising a handle on said first side, on the opposite side with respect to the second sides, said handle having the further function of distancing two consecutive lists during installation, using said template turned upside-down so as to insert the handle between said two strips.

17. A template according to claim 14, wherein longitudinal adjustment slots are present so as to determine the position of the said guide holes in variable manner in said gaps.

18. A template according to claim 17, comprising slides on the surface of said first side, adapted to adjust the position of said guide holes, in longitudinal direction on said adjustments slots.

19. A semiautomatic drilling and screwing systems, adapted to implement said assembly device and an assembly method according to claim 8, comprising:
a support, with corresponding gripping handles, the lower part of the support being positioned in contact with the strip to be fastened onto the section bar, to said lower part there being connected a pair of second vertical sides with corresponding slots, which during assembly are inserted on the section bars for centring;
automatic drills and screw runners with screw loaders, installed on said support, said drills and screw runners being positioned on slides which allow the translation in horizontal direction thereof to be positioned at the holes to be made and being thus manoeuvred by means of the pressure on vertical slides present on the side walls of the support to make the holes and perform the screwing.

20. A semiautomatic drilling and screwing system according to claim 19, wherein said drills and screw runners may be single or in pairs.
